(19) United States
(12) Patent Application Publication
(10) Pub. No.: US 2011/0010281 A1
(43) Pub. Date: Jan. 13, 2011

(54) System for supplying power to an electric vehicle on a parking space

(76) Inventor: Clemens Wass, Salzburg (AT)

Correspondence Address: FLYNN THIEL BOUTELL & TANIS, P.C., 2026 RAMBLING ROAD, KALAMAZOO, MI, 49008-1631, US

(21) Appl. No.: 12/803,311

(22) Filed: Jun. 24, 2010

(30) Foreign Application Priority Data
Jul. 8, 2009 (EP) 09008897.2

(51) Int. Cl. G06Q 30/00; H04B 7/00; G06Q 40/00

(52) U.S. Cl. 705/34; 455/41.2

(57) ABSTRACT

A system is proposed for supplying power to an electric vehicle on a parking space, which system has, for each parking space or for a group of parking spaces, a charging station which is assigned to the parking space or the group of parking spaces and which comprises means for supplying power to the electric car, for detecting the consumed power, for identifying or detecting the vehicle for the purpose of billing for the consumed power, and a device for paying for the consumed power.

The invention relates to a system for supplying power to an electric vehicle on a parking space according to the preamble of patent Claim 1.

Electric vehicles, in particular electric cars, have recently attracted increased attention. Particularly due to the development of accumulator technology and the increasing prices of fossil fuels, vehicles with purely electric drive are an alternative to conventional vehicles. In this context, an increase in the registered electric vehicles is to be expected in the next few years.

In order to be able to operate such vehicles, charging stations are necessary which serve to supply power, specifically to charge the accumulators of these vehicles.

The present invention is based on the object of specifying a system for supplying power to an electric vehicle on a parking space, by means of which system the accumulators of an electric vehicle can be made possible while the vehicle stays on the parking space, for example on a parking space of a multistory car park, and the payment of the consumed power is easily made possible.

This object is achieved for a system for supplying power to an electric vehicle on a parking space by means of the features of patent Claim 1. Further refinements and advantages according to the invention can be found in the subclaims.

Accordingly, a system for supplying power to an electric vehicle on a parking space is proposed, which system has, for each parking space or for a group of parking spaces, a charging station which is assigned to the parking space or the group of parking spaces and which comprises means for supplying power to the electric car, for detecting the consumed power and for identifying or detecting the vehicle for the purpose of billing for the consumed power.

The means for supplying power to an electric car are preferably embodied as a cable which can be connected to a corresponding location on the vehicle or as devices for contactless charging of the accumulators of the vehicle, for example by induction.

Furthermore, the system according to the invention comprises a device for paying for the consumed power, which device which can be integrated, for example, into an access control device for the parking space or for a multistory car park in which the parking space is provided.

According to one preferred embodiment of the invention, the means for identifying or detecting the vehicle are embodied as RFID or NFC-enabled devices; in this context there is provision that the user of the electric vehicle which is to be provided with power activates the power supply by an RFID or NFC interaction between a mobile device, for example a mobile phone, and the means for identifying or detecting the vehicle after the vehicle has been parked on a parking space and after the means for supplying power to the vehicle have been connected.

In this context, the vehicle is detected or identified by means of a unique assignment number, for example by means of the mobile phone number, the number of the SIM card or using a number which is to be allocated during the RFID or NFC interaction and is stored in the mobile device or in the mobile phone. The power consumption is assigned to this number, so that, after the termination of the supplying of power, the user can pay when the parking space is exited by means of a renewed RFID or NFC interaction between his mobile device and the payment device using credit card data or bank connection data stored in the mobile device or mobile phone or using a direct payment by means of the telephone number of the mobile phone.

Alternatively, after the renewed RFID or NFC interaction, the amount to be paid can be displayed on a display of the payment device, wherein the payment can subsequently be made by means of a credit card or with cash. In this context, this can be done from the vehicle if the payment device is integrated into an access control device, which may be the case in a multistory car park. In order to implement the procedure described above, the consumption information and the unique assignment number of the vehicle are transferred to the payment device, directly or via a central server which is connected to the payment device, from the means for identifying or detecting the vehicle.

According to a further embodiment of the invention, after the supplying of power to the vehicle has ended, the amount corresponding to the power consumption can be transmitted to the portable device, for example in the form of a unidimensional or two-dimensional barcode by means of a renewed RFID or NFC interaction between the user's portable device or mobile phone and the RFID or NFC-enabled device. When the parking space or the multistory car park is exited, the bar code is read out by an RFID or NFC interaction between the portable device and the payment device or the access control device or by means of a scanning process, and the amount to be paid is displayed. The payment is subsequently carried out as described above. This variant of the invention advantageously avoids the connection of the charging station to a central server.

If the payment device is integrated into an access control device, for example into an access control device of a multistory car park when the multistory car park is exited the amount which is made up of the power consumption and the parking fees is displayed as the amount to be paid. The payment of the consumed power is therefore advantageously carried out in one step with the payment of the parking fees.

According to a further embodiment of the invention, the means for identifying or detecting the electric vehicle comprise a device for detecting the license plate of the vehicle, wherein the supplying of power can be activated after the license plate has been detected. In this context, when the parking space is exited, the vehicle is identified on the basis of the same device, or a further device, for detecting license plates, and the amount to be paid, which corresponds to the power consumption, is displayed on the payment device. The procedure for payment preferably corresponds to the procedure specified above.

If the device for paying for the power consumption is integrated into an access control device, which may be the case, for example, in a multistory car park, it is expedient that the vehicle is detected on traveling into the multistory car park by means of the device for detecting license plates. In this way, when the multistory car park is exited the parking fee and the fee for the power consumption can be paid simultaneously, i.e. in one step, on the basis of the renewed detection of the license plate.

In addition, according to a further embodiment of the invention, there may be provision that the means for identifying or detecting the vehicle comprise a device for setting up a wireless network connection, for example a WLAN device, which can set up a connection to a device for setting up a wireless network connection or a WLAN device of the vehicle or of a portable device, for example of a user's mobile phone, via which connection a unique assignment number, for example the license plate of the vehicle, the mobile phone number or the number of the SIM card of the mobile phone, can be transmitted to the means for identifying or detecting the vehicle, wherein the power consumption can be assigned to the assignment number which is used for billing for the power consumption. The wireless network connection can also be established, for example, using an UMTS network.

It is also possible to allocate, by means of a wireless connection, a unique number as the assignment number, which is stored in a computer of the vehicle or in the portable device or in the user's mobile phone and is used, when the parking space or the multistory car park is exited, to display the amount corresponding to the power consumption in order to permit payment. The supplying of power can be activated after the assignment number has been transmitted.

After the supplying of power has ended, the amount to be paid is determined when the parking space is exited on the basis of the assignment number by means of a wireless network connection or a WLAN connection between a computer of the vehicle or the user's mobile device or mobile phone and the payment device; said amount to be paid can be paid, for example, using credit card data or bank connection data stored in the computer of the vehicle or in the user's mobile device or mobile phone or using a direct payment by means of the telephone number of the mobile phone, wherein the consumption information and the unique assignment number of the vehicle are transmitted to the payment device, directly or via a central server which is connected to the payment device, from the means for identifying or detecting the vehicle.

In the case of a multistory car park, when the vehicle enters a multistory car park said vehicle is detected on the basis of an assignment number described above by means of a wireless network connection or WLAN connection which is to be set up between the vehicle or the user's portable device or mobile phone and an access control device, so that, when the multistory car park is exited, both the parking fees and the fees corresponding to the power consumption can be paid in one step.

According to one particularly preferred embodiment of the invention it is proposed, for the case in which the supply of power to the electric vehicle takes place via a cable which is to be connected to the vehicle, the cable is embodied in such a way that in addition to the power line a data line is also provided via which the data which are used for identifying or detecting the vehicle can be transmitted from a computer of the vehicle to the charging station. In this context, the license plate of the vehicle can be transmitted to the charging station through the cable, so that, when the parking space is exited, the sum which is to be paid can be displayed on the basis of detection of the license plate of the vehicle. It is also possible for the sum which corresponds to the power consumption to be paid using credit card data or bank connection data stored in the computer of the vehicle, by means of the cable through a corresponding operator control operation by the user.

As an alternative to the embodiment of the cable with a power line and a data line, it can also be provided according to the invention that the transmission of data from a computer of the vehicle to the charging station for identifying or detecting the vehicle and for transferring credit card data or bank connection data takes place via the power line of the cable.

According to a further embodiment of the present invention it is proposed that the means for identifying or detecting the electric vehicle which is to be supplied with power comprise a reading device for an RFID card or NFC card, a barcode card or for a magnetic card wherein the supplying of power is activated by reading in the card. The driver of the vehicle can receive this card, for example, from a suitable device of the charging station; in the case of a multistory car park, this card is preferably the parking ticket which the driver receives when he drives into the multistory car park.

According to one variant of the invention, the number of the card or further suitable data which are stored on the card are read out by the means for identifying or detecting the electric vehicle which is to be supplied with power, wherein, in order to determine the amount which is to be paid for the supply of power, the card is read in via the payment device, wherein the assignment of the power consumption to the vehicle is carried out on the basis of the card number or the further suitable data stored on the card.

In the case of a multistory car park, when the parking fee is paid at the automatic parking payment device or at an access control device which is arranged at the exit the power consumption is assigned to the vehicle on the basis of the number of the card or of the parking ticket or on the basis of the further suitable data stored on the card, and the sum of the parking fees and the fees for the consumed power is displayed for payment.

In order to avoid networking of the charging station with the automatic parking payment device or with an access control device, which may be necessary for the procedure described above, it is possible to provide that, after the supplying of power has ended, renewed interaction of the card with the reading device takes place, wherein in this case the reading device is also embodied as a writing device for an RFID or NFC card, a barcode card or a magnetic card. In this context, the amount which is to be paid for the power consumption is encoded on the card, so that the user of the vehicle can use the card to pay the fees corresponding to the power consumption at an automatic parking payment device or at an access control device when he leaves the parking space or the multistory car park, wherein in the case of a multistory car park the parking fees can also be paid simultaneously.

In addition, in order to simplify the detection of the vehicle and the payment of the power consumption, the charging station can have, as means for identifying or detecting the vehicle, a reading device for power supply authorizations which have already been prepaid, wherein the supplying of power is started and ended after the reading in of a prepaid power supply authorization if the amount corresponding to the power consumption corresponds to the prepaid amount or if the accumulators of the vehicle are completely charged.

In particular, the charging station can have, as means for identifying or detecting the vehicle, a reading device for prepaid cards, so that the supplying of power starts after the reading in of a prepaid card which can be embodied as an RFID or NFC card or as a magnetic card.

Instead of a prepaid card, it is also possible to use a mobile phone or a portable device on whose display a unidimensional or two-dimensional barcode, which corresponds to an already paid amount for the supplying of power, is displayed. The barcode can be read by a scanning device of the system for supplying power. The “power credit” can be obtained, for example, by means of an RFID or NFC interaction with a device of the charging station, with a device in a multistory car park or else by means of an Internet-based transaction.

The system presented here for supplying power to an electric vehicle on a parking space can be implemented in multistory car parks, in car parks of supermarkets, hotels, airports, sports stadiums and the like.

1. System for supplying power to an electric vehicle on a parking space, characterized in that said system has, for each parking space or for a group of parking spaces, a charging station which is assigned to the parking space or the group of parking spaces and which comprises means for supplying power to the electric car, for detecting the consumed power, for identifying or detecting the vehicle for the purpose of billing for the consumed power, and a device for paying for the consumed power.

2. System for supplying power to an electric vehicle on a parking space, according to claim 1, characterized in that the means for identifying or detecting the vehicle are embodied as RFID or NFC-enabled devices, wherein the power supply can be activated by an RFID or NFC interaction between a mobile device or a mobile phone of the user of the electric vehicle and the means for identifying or detecting the vehicle, and wherein the vehicle can be detected or identified by means of the RFID or NFC interaction by means of a unique assignment number to which the power consumption can be assigned and which serves for billing for the power consumption.

3. System for supplying power to an electric vehicle on a parking space, according to claim 2, characterized in that the assignment number is the mobile phone number, the number of the SIM card of the mobile phone or a number which is to be allocated during the RFID or NFC

4. System for supplying power to an electric vehicle on a parking space, according to claim 2, characterized in that, after the termination of the supplying of power, the power consumption can be paid for when the parking space is exited by means of a renewed RFID or NFC interaction between the user's mobile device or mobile telephone and the payment device using credit card data or bank connection data stored in the mobile device or mobile phone or using a direct payment by means of the telephone number of the mobile phone, wherein the consumption information and the unique assignment number of the vehicle are transferred to the payment device, directly or via a central server which is connected to the payment device, from the means for identifying or detecting the vehicle.

5. System for supplying power to an electric vehicle on a parking space, according to claim 2, characterized in that, after the supplying of power has ended, the amount corresponding to the power consumption can be transmitted to the portable device or mobile phone in the form of a unidimensional or two-dimensional barcode by means of a renewed RFID or NFC interaction between the user's portable device or mobile phone and the RFID or NFC-enabled device of the charging station, wherein, when the parking space is exited, the barcode is read out by the payment device and the amount to be paid is displayed, and wherein the amount can be paid by using credit card data or bank connection data stored in the mobile device or mobile phone or using a direct payment by means of the telephone number of the mobile phone.

6. System for supplying power to an electric vehicle on a parking space, according to claim 1, characterized in that the means for identifying or detecting the vehicle comprise a device for detecting the license plate of the vehicle, wherein the supplying of power can be activated after the license plate has been detected, wherein, when the parking space is exited, the vehicle is identified on the basis of the same device, or a further device, for detecting license plates, and the amount to be paid, which corresponds to the power consumption, is displayed on the payment device.

7. System for supplying power to an electric vehicle on a parking space, according to claim 1, characterized in that the means for identifying or detecting the vehicle comprise a device for setting up a wireless network connection or a WLAN device via which a connection can be set up to a device for setting up a wireless network connection or a WLAN device of the vehicle or a portable device or a mobile phone of the user, by means of which a unique assignment number of the vehicle can be transmitted to the means for identifying or detecting the vehicle, wherein the supplying of power can be activated after the assignment number has been transmitted.

8. System for supplying power to an electric vehicle on a parking space, according to claim 7, characterized in that the assignment number is the license plate of the vehicle, the mobile phone number of the mobile phone, the number of the SIM card of the mobile phone or a number which is to be allocated via the wireless network connection or WLAN connection and is stored in a computer of the vehicle or in the mobile device or in the mobile phone.

9. System for supplying power to an electric vehicle on a parking space, according to claim 7, characterized in that, after the supplying of power has ended, the amount to be paid can be determined when the parking space is exited by means of a wireless network connection or a WLAN connection between a computer of the vehicle or the user's mobile device or mobile phone and the payment device on the basis of the assignment number, wherein the amount to be paid can be paid using credit card or bank connection data stored in the computer of the vehicle or in the user's mobile device or mobile phone or using a direct payment by means of the telephone number of the mobile phone, wherein the consumption information and the assignment number of the vehicle can be transmitted to the payment device, directly or via a central server which is connected to the payment device, from the means for identifying or detecting the vehicle.

10. System for supplying power to an electric vehicle on a parking space, according to claim 1, characterized in that if the supplying of power to the electric vehicle takes place via a cable which is to be connected to the vehicle, the cable is embodied in such a way that, in addition to the power line, a data line is also provided via which the data which are used for identifying or detecting the vehicle can be transmitted from a computer of the vehicle to the charging station, or in that the transmission of the data which is used for identifying or detecting the vehicle is transmitted from a computer of the vehicle to the charging station via the power line of the cable.

11. System for supplying power to an electric vehicle on a parking space, according to claim 10, characterized in that the license plate of the vehicle can be transmitted to the charging station via the cable, so that, when the parking space is exited, the sum which is to be paid can be displayed on the basis of detection of the license plate of the vehicle.

12. System for supplying power to an electric vehicle on a parking space, according to claim 10, characterized in that the sum corresponding to the power consumption can be paid by means of the cable using credit card data or bank connection data stored in the computer of the vehicle.

13. System for supplying power to an electric vehicle on a parking space, according to the claim 1, characterized in that the means for identifying or detecting the electric vehicle which is to be supplied with power comprise a reading device for an RFID card or NFC card, a barcode card or for a magnetic card, wherein the supplying of power is activated by reading in the card, wherein in the case of a multistory car park this card is the parking ticket which the driver receives when he drives into the multistory car park, and wherein, in order to determine the amount which is to paid for the supplying of power, the card is read in by the payment device, wherein the assignment of the power consumption to the vehicle is carried out on the basis of the card number or further data stored on the card.

14. System for supplying power to an electric vehicle on a parking space, according to claim 13, characterized in that in the case of a multistory car park, when the parking fee is paid at the automatic parking payment device or at an access control device which is arranged at the exit the sum of the parking fees and the fees for the consumed power is displayed for payment on the basis of the number of the card or of the parking ticket or on the basis of further data stored on the card.

15. System for supplying power to an electric vehicle, on a parking space, according to claim 13, characterized in that, after the supplying of power has ended, a renewed interaction takes place between the card and the reading device, wherein the reading device is also embodied as a writing device for an RFID or NFC card, a barcode card or a magnetic card, and the amount which is to be paid for the power consumption is encoded on the card.

16. System for supplying power to an electric vehicle on a parking space, according to claim 1, characterized in that the charging station has, as means for identifying or detecting the vehicle, a reading device for power supply authorizations which have already been prepaid, wherein the supplying of power is started and ended after the reading in of a prepaid power supply authorization if the amount corresponding to the power consumption corresponds to the prepaid amount or if the accumulators of the vehicle are completely charged.

17. System for supplying power to an electric vehicle on a parking space, according to claim 16, characterized in that said system has, as means for identifying or detecting the vehicle, a reading device for prepaid cards which are embodied as RFID cards or NFC cards or as magnetic cards, or in that the means for identifying or detecting the vehicle are embodied as scanning devices for unidimensional or two-dimensional barcodes which can be displayed on a display of a portable device or mobile phone.

18. System for supplying power to an electric vehicle on a parking space, according to claim 1, characterized in that if the parking space is provided in a multistory car park, the payment device is integrated into an access control device of the multistory car park, wherein the payment of the consumed power takes place in one step with the payment of the parking fees.
